(19) United States
(12) Patent Application Publication
(10) Pub. No.: US 2018/0102062 A1
(43) Pub. Date: Apr. 12, 2018

(54) Learning Map Methods and Systems

(71) Applicant: Itay Livni, Chicago, IL (US)

(72) Inventor: Itay Livni, Chicago, IL (US)

(21) Appl. No.: 15/727,586

(22) Filed: Oct. 7, 2017

Related U.S. Application Data
(60) Provisional application No. 62/405,247, filed on Oct. 7, 2016.

(51) Int. Cl. G09B 17/00; G09B 7/02; G06Q 50/20; G09B 5/02

(52) U.S. Cl. CPC G09B 17/003; G09B 5/02; G06Q 50/20; G09B 7/02

(57) ABSTRACT

Example implementations herein relate generating a learning map. One example method involves a computing device receiving user input indicative of a linguistic term and a topic. The method also involves selecting a plurality of primary sources that include text related to the topic. The method also involves determining a statistical model that characterizes relationships between the linguistic term of the user input and a plurality of linguistic terms included in the text of the selected primary sources. The method also involves generating a learning map that includes a plurality of learning paths for learning the linguistic term of the user input based on at least the statistical model. A given learning path includes a sequence of linguistic terms. Adjacent linguistic terms in the sequence are selected based on at least a statistical measure of a relationship between the adjacent linguistic terms.

### CROSS-REFERENCE TO RELATED APPLICATION

This application claims priority to U.S. Provisional Patent Application No. 62/405,247 filed on Oct. 7, 2016, the entirety of which is incorporated herein by reference.

### BACKGROUND

Traditionally, educational curriculums and other learning plans were developed subjectively to teach a sequence of educational concepts. These curriculum development methods may be based on a traditional learning theory, which suggests that humans have an innate universal grammar that can be defined by rules such as “noun phrases” and “verb phrases.”

As a result, for example, a learning plan may present a sequence of concepts according to a certain rigid structure, such as a determiner, an adjective, and a noun for teaching a sentence. As another example, preschool teachers may teach addition, then subtraction, then multiplication, etc., in an order based on an intuition of the person preparing the curriculum with respect to the underlying mathematical rules. As yet another example, an educational game may teach a sequence of concepts in the field of computers. To develop the educational game, for instance, a subject matter expert in the field may identify important concepts in the field, and then a software game developer may present these identified concepts through a subjectively chosen sequence of activities or levels of the game.

However, these methods may be challenging for some users. For example, some concepts, such as advanced scientific terms, may be more efficiently learned by a person who understands several underlying concepts first. Additionally, as human knowledge expands, a traditional learning sequence may become obsolete or less effective. Furthermore, a particular learning sequence may be more suitable for a particular student than it is for other students, depending on the existing knowledge and learning ability of the particular student, among other factors.

More recently, some research suggests that humans employ a “usage-based” learning model, where a human brain has a natural ability to identify patterns of usage that can be applied to different sentences. Through listening, for example, a child can learn patterns of usage of linguistic terms being applied in different sentences. For instance, the child may detect that the word “food” could replace the word “ball” after the phrase “the cat wants.” By accumulating knowledge and experience, in this example, the child can develop her own understanding of the linguistic terms: “the cat wants,” “ball,” and “food.”

Thus, it may be desirable for educators to develop learning plans according to the “usage-based” learning model. However, the amount and cost of research for this approach may present a challenge for some users (e.g., cost of researching use of terms, etc.). Additionally, the time it takes to perform such research may also be challenging (e.g., older textbooks may present information about floppy disks that may be obsolete, etc.). Additionally, subjectivity of a learning plan developer may lead to excluding some relevant language usage data that the learning plan developer subjectively deems irrelevant.

### SUMMARY

Example implementations herein relate to generating a learning map for learning a linguistic term based on statistical modelling of the usage of the linguistic term and other related linguistic terms in various contexts.

In one example, a method involves a computing device receiving user input indicative of a linguistic term and a topic. The method also involves selecting a plurality of primary sources of content that include text related to the topic. The method also involves determining a statistical model that characterizes relationships between the linguistic term of the user input and a plurality of linguistic terms included in the text of the selected primary sources. The determination of the statistical model may be based on at least contextual use of the linguistic term in the text of the selected primary sources. The method also involves generating a learning map based on at least the statistical model. The learning map includes a plurality of learning paths for learning the linguistic term of the user input. A given learning path includes a sequence of linguistic terms. Adjacent linguistic terms in the sequence are selected based on at least a statistical measure of a relationship between the adjacent linguistic terms.

In another example, a computing device includes one or more processors and data storage storing instructions that, when executed by the one or more processors, cause the computing device to perform the functions of the example method described above.

In yet another example, a non-transitory computer readable medium stores instructions that, when executed by one or more processors of a computing device, cause the computing device to perform the functions of the example method described above.

These as well as other aspects, advantages, and alternatives, will become apparent to those of ordinary skill in the art by reading the following detailed description, with reference where appropriate to the accompanying figures.

### BRIEF DESCRIPTION OF THE DRAWINGS

FIGS. 1A-1B illustrate a flowchart of a method, according to an example embodiment.

FIG. 2 illustrates a flowchart of a another method, according to an example embodiment.

FIG. 3 is a conceptual illustration of a graphical user interface (GUI), according to an example embodiment.

FIG. 4 is a conceptual illustration of another GUI, according to an example embodiment.

FIG. 5 is a simplified block diagram of a data communication system, according to an example embodiment.

FIG. 6 is a simplified block diagram of a device, according to an example embodiment.

FIG. 7 illustrates a flowchart of yet another method, according to an example embodiment.

### DETAILED DESCRIPTION

Example methods and systems are described herein. Any example implementation or feature described herein is not necessarily to be construed as preferred or advantageous over other implementations or features. The example implementations described herein are not meant to be limiting. Certain aspects of the disclosed methods and systems can be arranged and combined in a wide variety of different configurations. Furthermore, the particular arrangements shown in the Figures should not be viewed as limiting. It should be understood that other embodiments might include more or fewer of each element shown in a given Figure. Further, some of the illustrated elements may be combined or omitted. Yet further, an example embodiment may include elements that are not illustrated in the Figures.

Natural language processing (NLP) techniques provide statistical measures of linguistic characteristics that can indicate a learning difficulty of a word as well as define relationships between words. For example, a computer-implemented NLP process may involve parsing text to provide measured statistical quantities including readability statistics (e.g., readability index characterizing a reading difficulty, word length, grade level or age of a typical reader, etc.) of linguistic terms in the text, emotional valence statistics (e.g., negative emotions such as anger or fear, positive emotions such as joy, etc.) for quantifying the emotions described by a word or phrase in the text, frequency of use of a word in various contexts, and/or similarity or closeness statistics indicating relationships between words (e.g., frequency and context of use of a related word in text, etc.), among other linguistic characteristic statistics.

Thus, it may be desirable to utilize NLP techniques for developing learning plans that are suitable for a “usage-based” learning model or any other knowledge-based learning model. Accordingly, in some implementations, the present disclosure provides example methods, devices, and systems for doing so. Through this process, for instance, educators (e.g., teachers, educational software developers, etc.) as well as other users who are presenting a concept, word, object, etc., to a learning audience (e.g., salespersons, project managers, etc.) can efficiently and/or effectively educate their target audience.

In some implementations, an example computing device includes one or more processors and data storage storing instructions executable by the processor(s) to cause the computing device to perform operations. The operations may include receiving an input “search term,” which may include a word, phrase, or concept that a user provides as a teaching objective, for example. In some instances, the computing device may also receive input that identifies characteristics of a target learning audience, such as an age or range of ages for instance. In some instances, the received input may also indicate other parameters such as a target learning time period (e.g., hours, days, months, etc.) for teaching the search term, a preferred length of the output learning path (e.g., a maximum or minimum number of words in an output learning sequence, etc.), and/or an application of the output (e.g., for use in a game, school curriculum, product presentation, etc.), among other possibilities. By way of example, the computing device could operate a display to show a graphical user interface (GUI) that includes GUI elements such as any combination of text boxes, drop-down boxes, option buttons, etc., for receiving one or more of the inputs noted above.

The operations may also include generating and/or outputting a learning map that indicates relationships between the search term and other linguistic terms based on at least respective NLP characteristics associated with the search term and the other linguistic terms.

In a first example, the computing device could provide the learning map as a listing of learning paths, where each path includes a sequence of terms that have a threshold difficulty level and/or a threshold relationship (e.g., similarity score) to an adjacent word in the sequence. Consider an example scenario where the user is a science teacher that inputs the search term “bronchioles.” In this scenario, each word in an output learning sequence may indicate a scientific topic that could be delivered before the next topic in the sequence (e.g., “living things,” “animals,” “breathing,” “lungs,” “bronchi,” “bronchioles.”).

In a second example, the computing device could provide the learning map as a structured data file that has a particular file format. For instance, the learning map can be output as a java script object notation (JSON) data structure, or any other data file structure, that can be used by an application programming interface (API) of a game developer to receive the learning map. Thus, in an example scenario, the game developer can develop a generic game with little or no subject matter expert (SME) knowledge of the material that the game will teach. In the scenario, the game developer can then incorporate the educational subject matter of the game based on a JSON file output of the example computing device.

In a third example, the computing device can output the learning map as a sequence of speech sounds (e.g., via a speaker), or as any other type of output (e.g., haptic feedback, etc.).

In a fourth example, the computing device could display the learning map in a GUI by rendering a view of a three-dimensional (3D) surface (e.g., topographical map, etc.). The surface, for example, may indicate a spatial arrangement of points. One particular point on the surface may represent the search term input by the user. Other points on the surface may represent, respectively, words or linguistic terms that are directly or indirectly related to the search term of the particular point. Thus, for instance, the distance between the various points on the surface can be proportional to or otherwise indicate a relevance score or other NLP relationship metric that characterizes a similarity or relatedness of the respective terms associated with the separated points. Further, for instance, the elevation or relative height of a point on the surface may be proportional to a readability score or other difficulty measure of the word associated with the point. Thus, in this example, the user can visually assess one or more learning paths (e.g., sequence of words, etc.) that can be used to teach the search term as one or more respective lines that pass through a set of points along the surface. In some implementations, the computing device can allow the user to select a different learning path by choosing one or more points on the surface, de-selecting a point on a currently selected path, and/or selecting an alternative or replacement point for a point on a currently selected path, among other possibilities.

Regardless of the type of output, in some implementations, generating the learning map may involve the computing device determining a linked-list, tree, or graph data structure, among other possibilities. In an example graph data structure implementation, a node in the graph may store a linguistic term along with associated term-specific NLP characteristics such as a difficulty score, readability index, etc., of the term. Further, in this example, each node may be connected to one or more other nodes via one or more respective edges of the graph data structure. An edge may indicate NLP statistics, such as a relevance score (e.g., based on a number of times the terms in the connected nodes are mentioned in the same sentence, etc.), a similarity score (e.g., characterizing the similarity of the terms or definitions thereof, etc.), a learning transition difficulty score (e.g., based on a difference between difficulty and/or readability scores of the individual terms, etc.), and/or any other NLP statistic pertaining to a quantitative measure of the linguistic relationship between the two words.

In line with the discussion above, generating the learning map may involve identifying linguistic terms related to the input search term as well as computing NLP statistics characterizing relationships between various terms (e.g., nodes) added to the learning map. To facilitate this, in some implementations, the operations performed by the computing device may also include searching a corpus or other source of linguistic content that includes sentences or phrases using the search term. In some examples, the computing device could retrieve a definition of the search term (e.g., from a dictionary or other database), and then extract terms from the definition for inclusion as nodes in the learning map.

Additionally or alternatively, in some examples, the computing device could submit the search term (and/or other terms extracted from a definition thereof) as a search query to a search engine, such as any search engine that can search a corpus of linguistic content (e.g., the Internet). As noted above, a “usage based” learning model may rely on an accumulation of knowledge and experience of how a linguistic term is used with other terms. Thus, the relationship between two linguistic terms can be statistically measured, for instance, at least by accounting for the number of times that the two terms are used in the same document, paragraph, sentence, etc. Accordingly, in some instances, the example computing device can leverage usage of the search term and/or other identified related terms by a large number of users (e.g., Internet users, etc.) as a source of data for computing NLP characteristics (and thus the learning map).

Thus, in some examples, the computing device can receive search results based on a search query (e.g., website listing, etc.), and parse text associated with the search results (e.g., web pages) to identify additional nodes for inclusion in the learning map. Further, in some examples, the computing device can use the identified additional nodes to submit yet another search query, and responsively parse associated search query results to extract additional key terms (e.g., nodes, etc.) for inclusion in the learning map.

In some implementations, the computing device can optionally limit the size of the search corpus based on inputs from the user. For example, where the search term is identified as a scientific term via user input. The computing device can limit the search corpus to scientific articles or other specific source.

Additionally, in some implementations, the computing device can store computed NLP characteristics and relationships between key terms in a database for use in future searches. For example, a server can store a previously generated learning map that includes the key term (e.g., node) “computer.” When a new learning map is being generated that results in extracting the key term “computer,” an example system can retrieve the previously generated learning map and then connect it (along with all the previously identified related nodes thereof) with the new learning map currently being generated.

It is noted that the various example implementations, scenarios, and configurations described above are only for the sake of example. Other features, configurations, and implementations are possible as well and are described in greater detail within exemplary embodiments of the present disclosure.

Reference will now be made in detail to various implementations, examples of which are illustrated in the accompanying drawings. In the following detailed description, numerous specific details are set forth in order to provide a thorough understanding of the present disclosure and the described implementations. However, the present disclosure may be practiced without these specific details. In other instances, well-known methods, procedures, components, and circuits have not been described in detail so as not to unnecessarily obscure aspects of the various implementations.

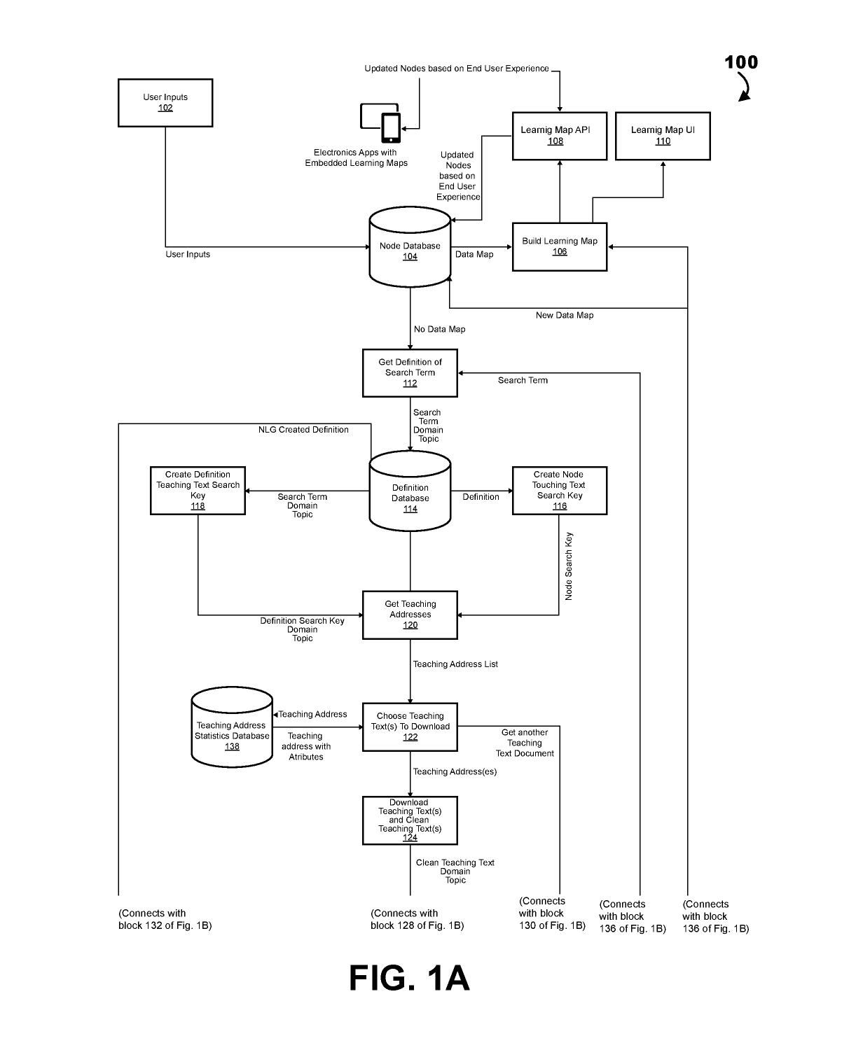

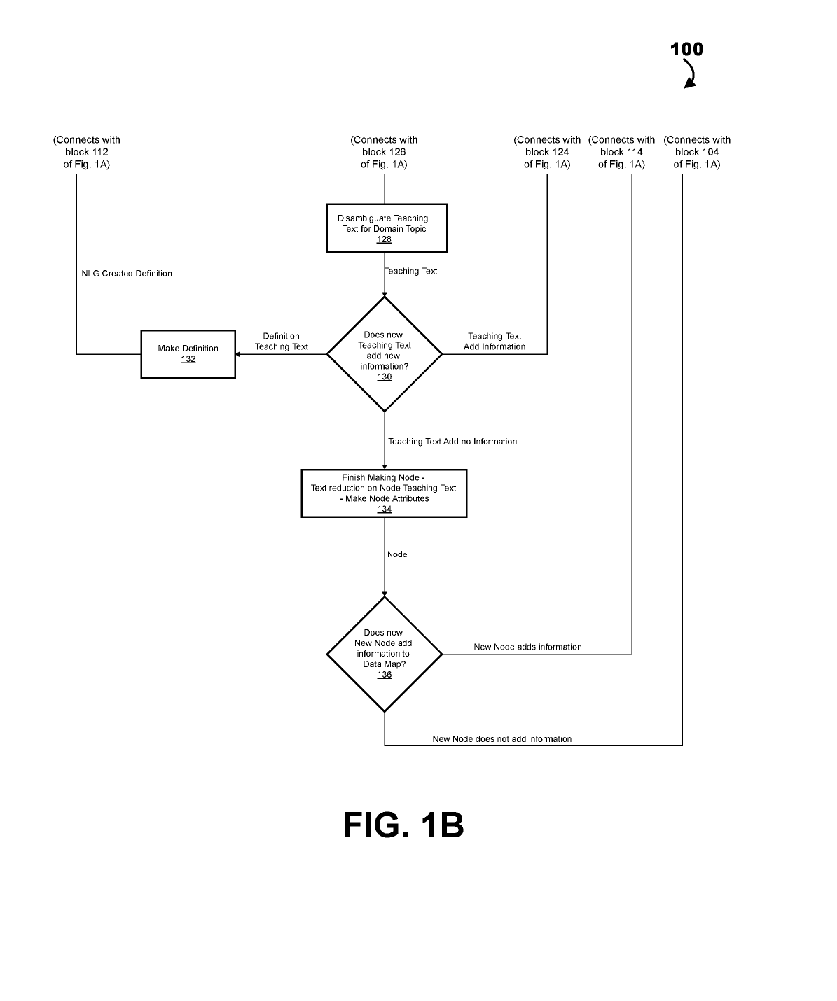

Method 100 depicted in FIGS. 1A-1B presents an example method that can be performed by one or more computing devices, such as a desktop computer, laptop computer, personal digital assistant (PDA), hand-held telephone, network server, or any other computing device, for instance. In some examples, method 100 may be performed by any combination of one or more suitable components described herein. FIG. 1 may include one or more operations, functions, or actions as illustrated by one or more of blocks 102-138. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for method 100 and other processes and methods disclosed herein, the flowcharts show functionality and operation of one possible implementation herein. In this regard, each block may represent a module, a segment, or a portion of program code, which includes one or more instructions executable by a processor for implementing specific logical functions or steps in a process. The program code may be stored on any type of computer readable medium, for example, such as a storage device including a disk or hard drive. The computer readable medium may include a non-transitory computer readable medium, for example, such as computer readable media that stores data for short periods of time like register memory, processor cache, or Random Access Memory (RAM). The computer readable medium may also include non-transitory media, such as secondary or persistent long term storage, like read-only memory (ROM), optical or magnetic disks, or compact-disc read-only memory (CD-ROM), for example. The computer readable medium may also be any other volatile or non-volatile storage system. The computer readable medium may be considered a computer readable storage medium, a tangible storage device, or other article of manufacture, for example.

In addition, for method 100, and other processes and methods disclosed herein, each block in the flowchart may represent circuitry that is wired to perform the specific logical functions in the process. For example, one or more field-programmable gate arrays (FPGA) and/or one or more application-specific integrated circuits (ASIC) can be configured to perform method 300 and/or other processes and methods disclosed herein.

At block 102, method 100 involves receiving user input or auto generated user input. Example inputs include any combination of search term, end user type, age or difficulty level, category, depth setting, among others.

The search term may be a word or phrase for which the user wants to learn, make a game, develop a learning map, develop an education curriculum, etc. By of example, where an output learning path includes a sequence of words recommended for learning the search term, the search term may correspond to the last word in the sequence.

The end user type input may include an indication of the type of user that will be using the output of the method. In a first example, a game designer user type may be interested in creating a learning map that transitions users or gamers to different levels of a game. For instance, a game user can follow a path to learn several words along the way to the target search term. Further, for instance, the game designer can also design a game that is connected to a server. In this instance, the game designer or the game application software can dynamically or automatically change the learning path (e.g., game stage, level, subject matter of game stage, etc.) if the game user is struggling to complete the game level (e.g., based on number of attempts, etc.). Thus, the game can dynamically adjust to an alternative learning path for a player who is struggling to reach the end point (and thus learning the search term) after a threshold number of attempts, for example.

In a second example, an educator user type (e.g., teacher) may be interested in the learning map or words that are suitable for a certain readability level (e.g., length of words, etc.). Similarly to the game designer, for instance, the teacher can design class activities according to the sequence of terms (e.g., education topics) along the learning path. In an example scenario, if the teacher reaches day seven of the teaching program based on a learning path and determines that the student progress over seven days is insufficient, then the teacher can return back to the learning map to select an alternative learning path (i.e., a different sequence of learning activities that also arrive or end at the activity related to the search term).

Thus, for instance, an example system may output, for an educator user type, a learning path that is efficient (e.g., shorter). Whereas, for instance, the system may output, for a game designer user type, a more complex path with increasing difficulties, etc. Additionally or alternatively, for a teacher or educator, the output may be presented as a map or learning path for instance. Whereas, for a game designer, the output (e.g., map) may be configured according to an input interface (e.g., application programming interface) of gaming software for instance. Other examples are possible as well.

The age or difficulty level may include an age of an intended audience of the learning map being generated. In some instances, this input parameter may be referred to as a “teaching text reading index.” The age or difficulty level may be a criterion that can be used to ensure that the words or nodes used in an output learning map are suitable for an expected end user's ability to understand the words. Further, this criterion may allow a game designer learning map to associate game difficulty with a metric associated with an educational curriculum that includes the various words. For example, a game can monitor statistics such as a success rate of a player attempting a particular game level, and then use the reading index to adjust a difficulty of the game level accordingly (e.g., replace word or term of the game level with an easier or harder word). Further, this criterion can be used by the example system to decide how many nodes to include in the output learning map. For instance, the system can apply various readability models (e.g., generalized linear models, support vector machines, etc.) to identify words that are suitable for the age or difficulty level input. Additionally, the system can limit the selected words to words that have a certain length, or a certain number of syllables.

The category input parameter can be used by the system to disambiguate or narrow choices for definition or node teaching text. For instance, the category may indicate a domain (e.g., physics, chemistry, etc.) and/or topic (e.g., computers, memory, etc.) of the search term input parameter. For example, the system may refine the search term or disambiguate the input search term based on the domain or topic. Thus, when searching for words to add to the learning map, an example system may ensure that new documents considered are related to the domain or topic identified in the input (e.g., semantic similarity, etc.). In some instances, an example computing system may apply a topic modeling algorithm (e.g., Mallet, etc.), a word sense disambiguation algorithm or model (e.g., Yarowsky, etc.), or any other word sense disambiguation model fitted to an NLP data set (e.g., scientific paper data sets, wiki data sets, etc.) to filter or reduce the number of words in the output according to the user identified domain or topic.

The depth input parameter may indicate a constraint or other threshold for controlling the time or detail that is included in the output learning map. For instance, the depth input parameter may indicate a time limit, a selection of databases to search, a maximum number of nodes in the output learning map, etc. For example, if the user chooses a ten minute search time, the system may constrict the detail level or number of nodes in the learning map. To facilitate this, for instance, the depth input parameter can be used with a text dimensionality reduction model (e.g., principal component analysis for NLP, etc.), to measure closeness (e.g., cosine similarity, etc.) between node teaching texts (e.g., documents used to assign a difficulty, etc., of a node), among other possibilities.

Thus, at block 102, an example system may provide a combination of user inputs to begin building a learning map. Further, the example system can combine the input parameters to generate a teaching node indicating the user request (e.g., search term, other input parameters).

At block 104, method 100 involves obtaining, via a node database, one or more nodes related to the search term. For example, the database may already include the teaching node of the search term (e.g., along with a predetermined difficulty level, relationships to other nodes or words, etc.) from a previously computed search. Further, for example, the database may include an indication of other nodes that were previously determined to have a relationship or be along a learning path (e.g., in a graph) connected to the teaching node (e.g., search term). For instance, if the search term is “e-mail,” a previous search may have identified the words “computer” and “message” as related words that have respective difficulty levels and strength of relationship to the term “e-mail”.

At block 106, method 100 involves generating a learning map based on the one or more nodes obtained at block 104. For instance, an example system can overlay search terms of the various nodes to determine individual learning paths and create a mesh of paths. The mesh of path, for example, can be implemented as a graph data structure where each node represents a search term (e.g., the input search term and other search terms in the nodes selected at block 104). Further, edges connecting the various nodes may have various edge lengths according to various difficulty statistics suitable for the end user type of the learning map. Example difficulty statistics include any combination of word length, teaching text reading index (e.g., suitable age for understanding the search terms connected by the edge, etc.), word blending metric (e.g., the node for the word “smog” can have a low blending metric value between the nodes for the words “smoke” and “fog,” etc.), other word formation metrics (e.g., calque, neologism, etc.). Thus, by analyzing one or more of such node difficulty statistics using respective natural language processing (NLP) processes, the various nodes in the map can be related to one another via edges of the graph data structure, for instance. For example, the nodes in the resulting learning map can be filtered according to age, difficulty, time for learning, purpose of learning map, etc., which may be indicated in the input parameters received at block 102. Further, the node statistics can be used as a basis for identifying alternative paths for learning the teaching node search term.

Thus, an example computing system may generate a learning map file object, such as a structured dataset, java script object notation (JSON) data structure, or any other file format suitable for the end user type. By way of example, a game developer may utilize a JSON file type to analyze and extract learning paths from the learning map object. In this example, the system can provide the JSON file for access by the game developer (or game application) using an application programing interface (API) 108.

Thus, at block 108, method 100 involves allowing access to the learning map object generated at block 106 via an API. In some examples, method 100 also involves receiving feedback associated with the nodes or paths of the learning map object via the API 108. In one example, a game application (or developer) may use API 108 to indicate a preference for a particular learning path in the map, to request additional nodes or details between two particular nodes in the map, to modify or suggest a different difficulty or other node statistic determined at block 106, etc. In turn, an example computing system may modify or update the nodes in node database 104 based on the user input or feedback received from API 108. For instance, the learning map may indicate a path between the teaching node search term “e-mail” and another node search term “network.” In this instance, the game application (or education provider) utilizing API 108 may request additional nodes between the word “email” and the word “network,” or may indicate that the edge length (e.g., difficulty of transition, etc.) between those two words should be different than that determined at block 106. Thus, in this instance, the system can update the node database 104 accordingly, search for additional nodes between those two nodes in the database 104, and/or generate additional nodes for storage in the database 104 and for updating the learning map.

Additionally or alternatively, at block 110, method 100 involves allowing access to the learning map object generated at block 106 via a graphical user interface (GUI). For instance, an example computing system may condition or format the data in the learning map object for display in a computer screen, a UI application, and/or a web page, among other possibilities. The GUI, for instance, can display a particular path of nodes to learn the input search term, including an arrangement of verbs and adjectives to learn along the learning path. Further, for instance, the GUI can display a higher level view of clusters of nodes surrounding the input search term in the learning map graph. As noted above, the nodes in a cluster may be grouped according to various node statistics, such as a frequency of use of the terms in the nodes in conjunction with the input search term (e.g., in the same document, etc.). Additionally, for example, the GUI can display a definition of the input search term.

In some scenarios, as noted at block 108, the database 104 may not include sufficient nodes for generating the learning map (block 106) according to the input parameters (e.g., end user type, desired difficulty level or age, etc.).

Thus, at block 112, method 100 involves determining a definition of the search term based on the one or more nodes obtained at block 104. In some instances, the one or more nodes may comprise just the teaching node (i.e., the node generated for the input parameters of block 102). Thus, for example, the determination at block 112 can be based on input parameters such as the search term, the age of the learning audience, the topic of the search term, the domain of the search term, etc. Further, in some instances, the one or more nodes may also include other nodes that were predetermined and stored in database 104 along with an indication of a relationship or learning path to the teaching node.

In one example, the system may determine that the definition of the search term exists in a definition database 114. If the definition exists, the system at block 112 may retrieve the definition from the database. In another example, where the definition is not included in the database, the system may perform other processes to create the definition of the search term.

Thus, at block 114, the definition database may receive inputs such as search term, age, topic, domain, etc. Further, the database 114 may store words/search terms mapped to respective definitions as well as various input parameters such as topic and domain attributes. In some examples, database 114 may also store a respective reading difficulty index for each respective word/search term stored in the database. A reading difficulty index may be a score determined using a natural language process (NLP) to rate the level of reading difficulty of a word, based on factors such as age of reader, Coleman Liau index, etc. The reading difficulty index or readability index may be normalized in various ways or may include a weighted average of multiple types of readability indexes, among other possibilities. If the input search term is already associated with one or more definitions in database 114, then the computing system can select a suitable definition from database 114, use the selected definition for generating a search key to search for additional words or terms related to the input search term. If the input search term is not associated with any definition in database 114, then the system can use the search term as a basis for generating a search key to search for additional terms or words. Thus, in some examples, regardless of whether the database 114 includes a definition for the input search term, the system can then proceed with generating a search key and searching for additional terms to create new nodes for the learning map.

Accordingly, at block 116, method 100 may involve generating a search key, where the definition of the input search term is not included in database 114. In this example, the search key may be referred to herein as a “node search key.” For instance, the computing system may use a search key definition template to create the node search key. The search key definition template, for instance, may comprise words or terms of nodes stored in database 104 that have some form of relationship to the input search term. Thus, the search key can be generated at block 116 as a concatenation of words or terms that may be related to the input search term by retrieving these terms from nodes database 104, as well as the search term itself. Further, in some examples, the search key may also include the domain, topic, other category input parameter, age, difficulty level, and/or any other input parameter, which can be concatenated with the input search term to generate the search key. Alternatively or additionally, in some examples, method 100 may involve improving search accuracy by determining an intent of the user and/or a contextual meaning of the search term based on the search results. Thus, for instance, the concatenation of words or terms can be selected based on web statistics or other relationship indicators returned by a search engine that receives the search key including the input search term (e.g., semantic search, etc.).

Alternatively, at block 118, method 100 may involve generating the search key, where the definition is included in database 114. In this example, the search key may be referred to herein as a “definition search key.” For example, the computing system can execute an NLP key term extraction or other text processing algorithm by providing the obtained definition (and/or the domain, topic, etc.) as an input to the NLP algorithm and receiving, from the NLP algorithm, one or more key terms for concatenation in the search key. Example NLP and/or other text processing algorithms, for example, may use statistics related to term frequency and/or context within the definition as a basis for extracting the key terms.

At block 120, method 100 involves obtaining definition teaching addresses based on the search key generated at block 116 or 118. For example, the computing system may generate and transmit a search query to an internet search engine or any other database search engine. In this example, the system may then receive, from the search engine, the teaching addresses as web links to web pages that contain text related to the search key and/or other teaching material, and/or any other reference or link to the teaching text or material. Thus, a teaching address may include any reference or identifier for a document or other content that is identified based on the search key, for instance. Further, the computing system can store a listing of the obtained teaching addresses in a data structure or database implementation, for instance.

At block 122, method 100 involves selecting one or more of the obtained teaching addresses, and obtaining (e.g., via a network, from an indexed database, etc.) the teaching text (e.g., content, document, web page, etc.) associated with the selected teaching addresses. In a first example, the selection at block 122 can be based on comparing metadata (or other information associated with or included in the teaching text) to various metrics, such as relevancy of the teaching text to a domain, topic, or category indicated in the input parameters 102. In a second example, the selection can be based on a random, pseudorandom, or other sampling process for selecting a subset of the obtained teaching text addresses. In a third example, the selection can be based on a ranking index or other classification information obtained using the search engine associated with the teaching addresses. In a fourth example, the selection at block 122 may comprise filtering teaching addresses that identify duplicate documents or translations of the same document.

Thus, in some examples, method 100 at block 138 may include storing and/or filtering teaching address statistics in database 138 to facilitate the selection of block 122.

At block 124, method 100 involves pruning the raw teaching text content (e.g., documents, etc.) obtained at block 122. In one example, the pruning may comprise converting the teaching text to a format suitable for NLP processing. For instance, the computing system can apply standard text pre-processing techniques to extract textual content portable document format (PDF) files, hypertext meta language (HTML) files, etc., and convert the extracted content to a uniform format (e.g., XML format, data structure, etc.) suitable for various NLP statistical models and/or algorithms. In another example, the pruning at block 124 may comprise executing various text mining pre-processing transformations, such as conversion to lower case, removing punctuation characters, removing or modifying numbers and/or stop words (e.g., common words such as “the,” etc.), word stemming, etc.

At block 128, method 100 involves filtering the pruned teaching text based on the category input parameter (e.g., domain, topic, etc.). For example, the computing system can use a topic modeling NLP process (e.g., Mallet, etc.) to filter out documents or words that do not have a threshold semantic similarity with the topic or category of the input search term, in line with the discussion of the category input parameter at block 102. As another example, the computing system can compare the semantic meaning or data structure associated with the teaching text to corresponding semantic meanings or data structures associated with existing nodes in database 104. Through this process, for instance, less relevant terms can be removed from the teaching text to disambiguate or improve the likelihood of relevance between the results included in the learning map. In some examples, the filtered teaching text of block 128 may be referred to herein as “clean definition teaching text.”

At block 130, method 100 involves determining whether the “clean definition teaching text” of block 128 provides at least a threshold amount of additional information relative to previously selected teaching text. For example, the process described at blocks 122-130 can be repeated iteratively for each selected teaching address of block 122. After each iteration, a combined (e.g., concatenated) text blob of teaching text can be updated to include additional words or terms identified in the filtered teaching text at the current iteration. Further, the computing system can compute a quantity of the additional words or terms identified at the current iteration. If the quantity is greater than the threshold, then the computing system may repeat block 122 to analyze the next textual text document associated with the selected one or more teaching addresses. If the quantity is less than the threshold, then the computing system may stop the iterative computations and proceed to block 132 and/or 134. As another example, the computing system may determine whether the threshold amount of additional information was determined at the current iteration by using an NLP process for testing information duplication and/or orthogonality.

At block 132, method 100 may involve generating a definition for the input search term. In some instances, the generation at block 132 may be performed where a definition for the input search term does not exist in database 112 (e.g., block 116). Thus, the present disclosure may allow for generating a search term search key even if a definition is not available by generating the definition at block 132. In other instances, the generation at block 132 can be performed even if another definition for the input search term exists in database 112. Thus, for instance, the computing system can continuously improve and add definitions for the search term into database 112 over time. Thus, in some examples, the generated definition at block 132 can then be stored in database 112 along with indexing data such as domain, topic, category, difficulty, etc., to allow or improve subsequent search key generation (e.g., block 118).

In a first example, generating the definition at block 132 may involve using the definition or clean teaching text “blob” of block 130 as an input for a natural language generation (NLG) process, such as the Pollen Forecast for Scotland system for instance. In a second example, generating the definition may involve retrieving the definition, based on the clean teaching text, using a defining dictionary template, a YSEOP data processing algorithm, a Narrative Science data processing algorithm, etc. In a third example, generating the definition may involve comparing a semantic similarity metric with a corresponding metric of an existing corpus (e.g., Wordnet, Wordnik, etc.) via a network.

At block 134, method 100 involves generating one or more nodes based on the teaching text (e.g., “node teaching text”) of block 130. For example, the computing system can extract a list of key terms from the teaching text that have certain linguistic attributes (e.g., verbs, adjectives, etc.). The computing system can then calculate a node teaching text readability index value(s) for the selected key terms, in line with the discussion above. For instance, connecting a first verb with the input search term may be associated with a readability index value different from a combination of a second verb with the input search term. The computing system can also calculate a closeness metric of a node (or key term) with the input search term or another node in the learning map. To do so, the computing system can use various NLP processes, such as readability statistics, key term metrics, part-of-speech (POS) tagging, etc.

At block 136, method 100 involves determining whether the one or more generated nodes include at least a threshold number of additional key terms other than key terms associated with other nodes included in the learning map of block 106 (i.e., the other nodes associated with the input search term). In an example scenario, at least one of the generated nodes may indicate a key term that is already included in a previously determined node (e.g., stored in database 104). In practice, for instance, a sufficient number of parsed or analyzed documents (teaching text) may have been previously analyzed such that few or no additional nodes (or key terms thereof) are found by analyzing additional teaching text content. Thus, if less than a threshold number of new nodes are found, the system can at block 136 can decide to stop searching or parsing additional teaching text (e.g., return to block 104). Further, at this point, if the node database still does not include enough nodes to improve the learning map, then the system can optionally generate an error message indicating failure to find additional nodes per the user request.

Whereas, for instance, if more than the threshold number of new nodes are found (i.e., additional information can be added to the learning map), then the system can update the node database 104, definition database 114, and/or learning map 106. Further, in this instance, the system can also repeat the process of blocks 114-130 using the new definitions and/or nodes added to database 114.

Note that the threshold can be any threshold (e.g., one node, ten nodes, or any number of nodes) depending on various applications of the computing system performing method 100. For example, the threshold can be determined based on a desired time limit for generating the learning map and/or updating the learning map. For instance, as the time limit approaches, the system can increase the threshold.

In some examples, the determination at block 136 may comprise applying various NLP processes to the data (e.g., key terms, definition, etc.) in the generated nodes, such as information orthogonality, duplication, text cleaning algorithms and the like, similarly to the processes described at block 130 for instance.

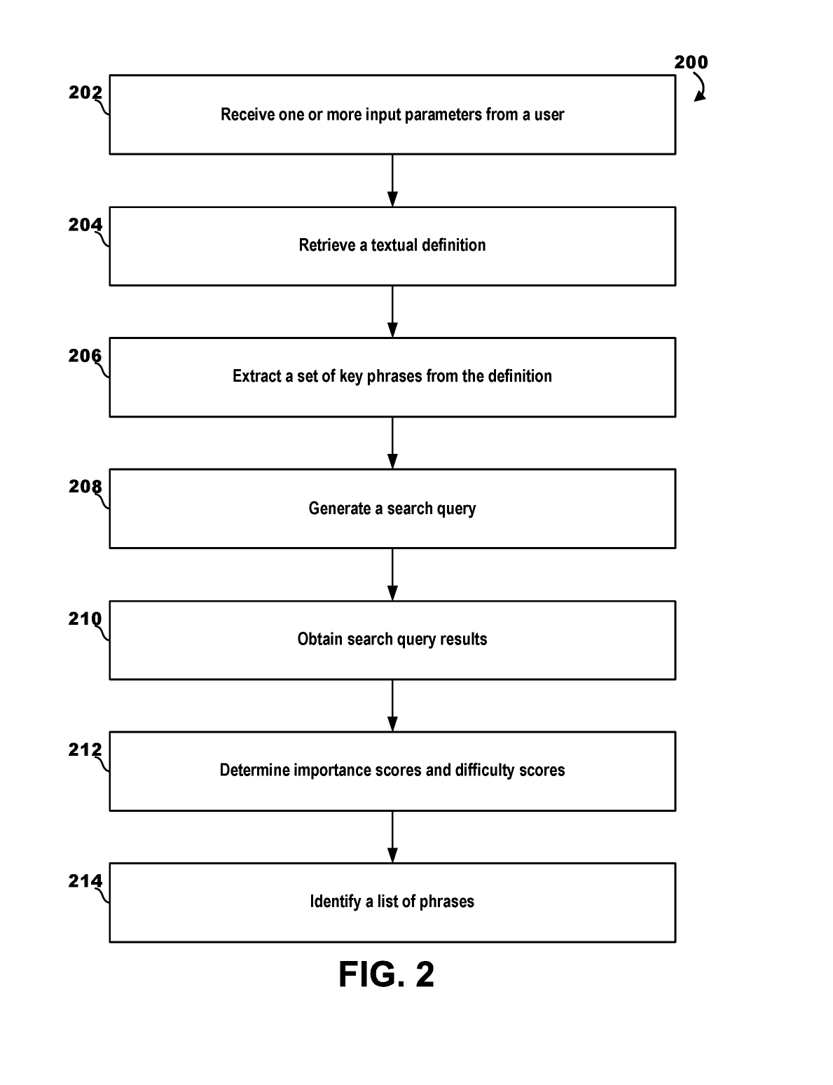

FIG. 2 illustrates another method, according to an example embodiment. Method 200 depicted in FIG. 2 presents an example method that can be performed by one or more computing devices, such as a desktop computer, laptop computer, personal digital assistant (PDA), hand-held telephone, network server, or any other computing device or system of the present disclosure, for instance. In some examples, method 200 may be performed by any combination of one or more suitable components described herein. FIG. 2 may include one or more operations, functions, or actions as illustrated by one or more of blocks 202-214. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

At block 202, method 200 involves a computing device receiving one or more input parameters from a user. The input parameters may indicate a textual phrase (e.g., word, sentence, etc.), a target learning difficulty level (e.g., age group, etc.), and a target learning duration (e.g., number of hours, number of months, etc.).

At block 204, method 200 involves the computing device retrieving a textual definition related to the textual phrase from a database. The database, for example, may include a dictionary or a customized listing of definitions that are grouped according to age or other parameter. Thus, in some embodiments, a definition may be selected based on educational rules (e.g., word length, etc.) related to the target learning difficulty level. In some examples, the database may include definitions, key phrases, and/or other information that was previously determined or updated by the computing device of method 200, similarly to databases 104, 114, 138, etc.

At block 206, method 200 extracting a set of key phrases from the definition. For example, a keyword extraction NLP process can be employed to extract the key phrases based on factors like part-of-speech (POS) characteristics, syntax characteristics, etc. Thus, in some embodiments, the method may also comprise the computing device determining a set of linguistic characteristics for the retrieved definition, and extracting the set of key phrases based on the linguistic characteristics. For example, the set of linguistic characteristics may indicate a sequence of textual subsets of the definition (e.g., parsed portions of the phrases, etc.), as well as POS characteristics and/or syntax characteristics of the parsed portions.

At block 208, method 200 involves generating a search query including a combined set of phrases. The combined set may include the textual phrase of the input parameters and the set of key phrases. In some embodiments, the search query may also include an indication of an indication of an educational topic related to the textual phrase. For example, the educational topic may be indicated in the received input parameters. Further, in some embodiments, the method may also involve determining a set of similar words or phrases based on determined (NLP) linguistic characteristics. For example, a similarity metric may indicate an extent of similarity between an extracted key phrase and a similar key phrase. Linguistic characteristics such as word vector comparisons and the like can be used to determine the similarity metric, for example. In these embodiments, the search query may also include the set of similar words.

At block 210, method 200 involves obtaining search query results based on the generated search query. The search query results may indicate content from a plurality of sources. For instance, the search query results may include a plurality of URLs of web pages that are related to text in the search query. Thus, for example, the computing device may access the web pages referenced by the URLs and extract textual content from the web pages as the content from the plurality of sources.

At block 212, method 200 involves determining importance scores and difficulty scores for each phrase in the combined set of phrases based on the content. An importance score may indicate an extent of relevance between a first phrase and a second phrase. A difficulty score may indicate a learning difficulty level of the phrase (e.g., based on word length or other linguistic characteristics). In some embodiments, the method may include extracting text from the content of the sources indicated by the search query results, and determining statistical relationships between the combined set of keywords based on the extracted text. For instance, the computing device may be configured to determine a graph data structure having a plurality of nodes and a plurality of edges between the nodes. Each node may correspond to a phrase of the combined set of phrases, and each edge may characterize to one or more of an importance score or a difficulty score.

At block 214, method 200 involves identifying a list of phrases, including the textual phrase of the input parameters, from within the combined set of phrases. The list may be identified based on the difficulty scores, importance scores, and/or target learning difficulty. Further, for example, the list may be ordered based on importance scores of each phrase relative to the textual phrase of the importance parameters. A quantity of phrases in the list may be based on the target learning duration. Thus, for example, the computing device of the present method may provide a user with a learning map or path with phrases ordered in accordance with NLP metrics to facilitate learning the textual phrase in the input parameters based on other factors in the input parameters (e.g., target learning duration, target learning difficulty level, etc.).

Further, in some examples, method 200 may also involve providing an output indicative of the list of phrases according to the order of the phrases (and/or importance parameters, statistical relationships, etc.). For example, a display of the computing device may display a graph representation or other 3D rendering of a learning map or learning path based on the determined relationships between the key phrases or nodes in the list.

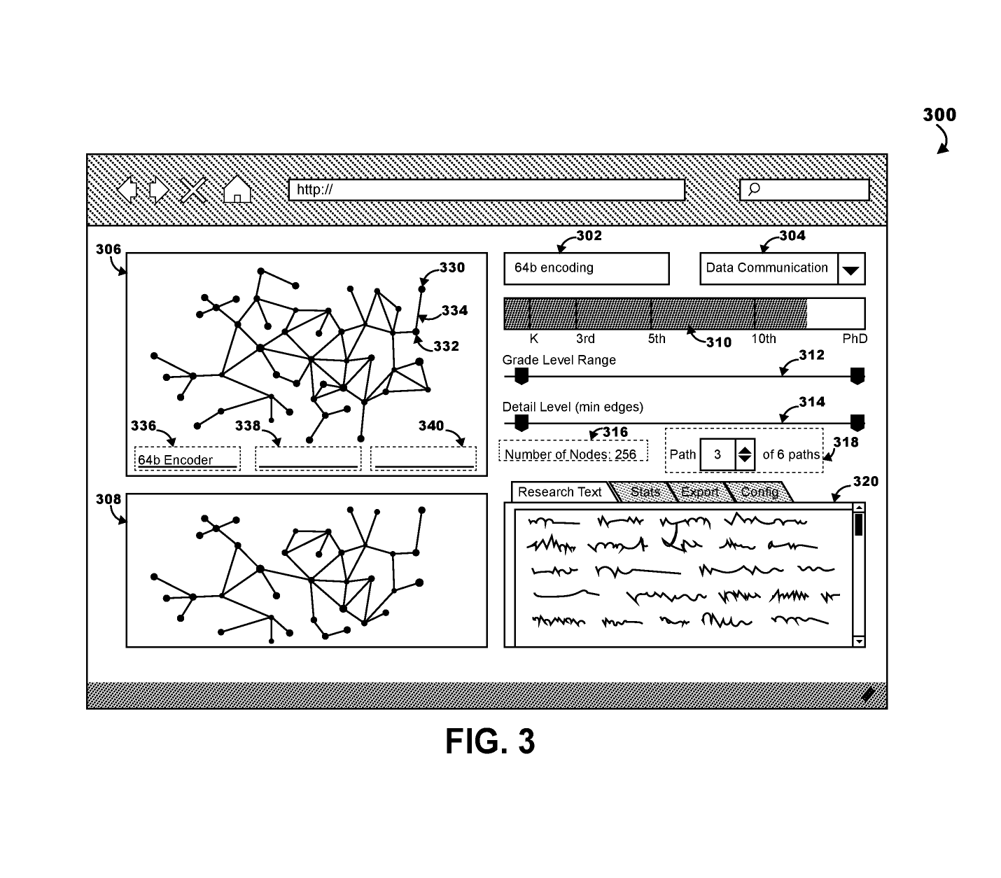

FIG. 3 is a conceptual illustration of an example graphical user interface (GUI) 300 that can be used with any of methods 100, 200, as well as other devices, systems, and/or methods of the present disclosure. For example, GUI 300 can be an example implementation for UI 110. In some examples, GUI 300 can be implemented as stored program instructions that are executable by one or more computing devices or servers to render a display of the GUI 300, receive inputs from a user of GUI 300, and/or provide various outputs in accordance with the present disclosure. As shown, for example, GUI 300 can be generated based on data from a server that is conditioned for display via a web browser application. Alternatively however, one or more components of GUI 300 can be implemented using an application that runs on a computing device without the use of a web browser application. Other implementations are possible.

As shown, GUI 300 includes UI elements 302-320.

UI element 302 can be configured to receive a search term. For example, as shown, the search term is “69b encoding”

UI element 304 can provide various selectable topics (e.g., educational fields, domains, etc.) from which a user can select a particular topic or educational area (e.g., math, physics, chemistry, data communication, etc.) that encompasses the search term entered via UI 302. As shown, for example, the topic of “Data Communication” is selected for the linguistic search term “64b encoding.” Other examples are possible.

UI element 306 (e.g., “Raw Graph Container”) provides a display of a learning map that is generated based on various user inputs (e.g., search term, topic, etc.). As shown, for example, the learning map can be displayed as a network graph that includes a plurality of nodes, exemplified by nodes 330, 332, and a plurality of edges, exemplified by edge 334, between the respective nodes. For example, each node may represent a respective linguistic term, and each edge may represent a statistical relationship between two respective linguistic terms. For example, edge 334 may indicate a statistical relationship (e.g., frequency of use, importance score, etc.) between nodes 330 and 332.

As shown, UI element 306 may include a plurality of node containers, exemplified by containers 336, 338, 340, that can receive a user selection of particular nodes from the network graph displayed in UI element 306. As an example, a user can operate an input device of an example system herein (e.g., mouse, touchscreen, etc.) to select particular nodes from the network graph (e.g., “drag” a node using a mouse into one of the containers, etc.). In some examples, the system can then generate a filtered learning map that includes nodes and edges between adjacent nodes, and exclude nodes and edges that are not between any pair of adjacent nodes selected in containers 336, 338, 340.

Although three containers 336, 338, 340 are shown, in some examples, UI element 306 may include fewer or more containers.

To that end, UI element 308 may include a display of a filtered learning map (e.g., filtered network graph based on the inputs in containers 336, 338, 340 or other filter inputs in GUI 300, etc.).

As shown, UI element 310 may include a display of an average grade level (or other statistical measurement of learning difficulty) of the linguistic terms in the learning map of UI element 306 and/or 308.

UI element 312 may be configured receive user input indicating a range of grade levels (or other learning difficulty statistical quantity). To that end, for example, GUI 300 may be configured to update UI elements 306, 308, 310, etc., based on the user input received via UI element 310

UI element 314 may be configured to receive user input indicating a range of the number of edges selected by for learning paths in the learning maps displayed in UI element 306 and/or 308. For example, the network graph displayed in UI element 306 can be updated to include shorter or longer learning paths (e.g., sequences of linguistic terms) that terminate at the input linguistic term (e.g., “64 b encoding”). For example, a user of GUI 300 can generate a customized learning path depending on the time available for teaching the linguistic search term in a curriculum, game, etc., by adjusting the “detail level” range input of UI element 314.

UI element 316 may be configured to provide a display of the number of nodes in the filtered graph (e.g., UI element 308) after the various filters described above is applied.

UI element 318 may be configured to receive an input for selecting a particular learning path in the network graph of UI element 306 and/or 308. For example, a learning path may correspond to a sequence of nodes that terminate at the node associated with the search term.

UI element 320 may be configured to provide selectable tabs for analyzing, viewing, and/or outputting various types of information related to the learning maps generated by the computing device of GUI 300. In a first example, the “research text” tab may display a combination of text content (e.g., definitions, etc.) that are retrieved from external sources (e.g., dictionaries, etc.) for the search term in the user input. In a second example, the “Stats” tab may provide a display of key terms (e.g., nodes) in the learning map ordered according to various statistical quantities (e.g., importance scores, grade levels, difficulty scores, other NLP statistics based on the “research text”, etc.). In a third example, the “export” tab may provide a user interface for selecting types of output based on the information in the (e.g., filtered, raw etc.) learning map. For example, a user can select, via UI 320, file types such as JSON, GPICKLE, CSV, GML, NEO4, SQL, or any other format for outputting the network graph or a subset thereof (e.g., select learning paths, etc.). In this example, the formatted data output via the “Export” tab can then be used to operate or create another application (e.g., educational curriculum, educational game, etc.). Other examples are possible as well.

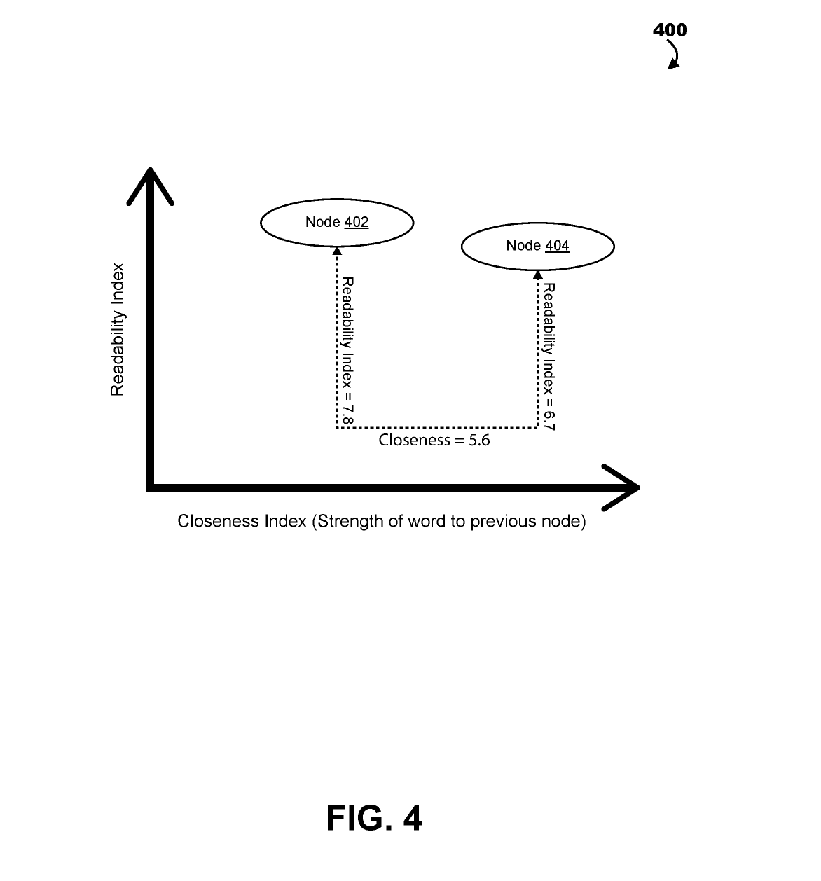

FIG. 4 is a conceptual illustration of another example graphical user interface (GUI) 400 that can be used with any of methods 100-200, and/or the GUI 300. In one example, GUI 400 can be an example implementation for UI 110. In another example, GUI 400 may correspond to a close-up view of one or more nodes in learning map 314 and/or learning path 316.

It is noted that GUI 400 is shown as a two-dimensional output for convenience in description. In some examples, GUI 400 can be implemented as a three-dimensional representation of one or more nodes.

As shown, GUI 400 includes two nodes 402, 404 that are arranged vertically according to a readability index value (e.g., according to the illustrated vertical axis) and horizontally according to a closeness index value (e.g., according to the illustrated horizontal axis). The readability values assigned to each node may correspond, respectively, to a readability index statistic (e.g., describing difficulty, etc.) of a word or phrase associated with the respective node, using the methods 100 and/or 200, for example. Similarly, the closeness values assigned to each node may correspond, respectively, to a closeness index statistic that describes the closeness of the words associated with each node (e.g., frequency of use of the two words in the same sentence, paragraph, document, etc.), as computed according to the description of methods 100 and/or 200, for example.

Thus, for instance, node 402 may have a higher difficulty (i.e., readability index) measure of 7.8 relative to a corresponding difficulty of 6.7 computed for node 404. Further, for instance, the closeness of the two terms can be indicated by a horizontal distance of 5.6 between the two nodes. Through this implementation, for instance, a user can visually inspect a plurality of nodes, including nodes 402 and 404 as well as other nodes (not shown), to select or evaluate a learning path that includes the two nodes 402 and 404. In one example, GUI 404 can be implemented as a 3D topographical map (not shown) of nodes that are separated horizontally by a measure of closeness between respective nodes and vertically (e.g., elevational height) according to corresponding readability measures of the respective nodes. Other variations are possible as well for visually inspecting and/or interacting with learning map 314 and/or learning path 316.

In some examples, the methods, devices, and systems described herein can be implemented using client devices and/or server devices (e.g., cloud-based servers, etc.). For instance, client devices, such as mobile phones, tablet computers, wearable computing devices, desktop computers, etc., may offload some processing and storage responsibilities to one or more remote server devices. In some implementations, client services are configured to communicate, via a network such as the Internet or any other public or private network (e.g., intranet, etc.), with the server device(s). Thus, for instance, applications that operate on the client devices may also have a server-based component. Alternatively, one or more of the methods, processes, and techniques herein may be implemented entirely on a client device or a server device.

It is noted that the “server devices” described herein may not necessarily be associated with a client/server architecture, and therefore may also be referred to as “computing devices” or “remote devices.” Further, “client devices” described herein may not necessarily be associated with a client/server architecture, and therefore may be interchangeably referred to as “user devices” or “computing devices.”

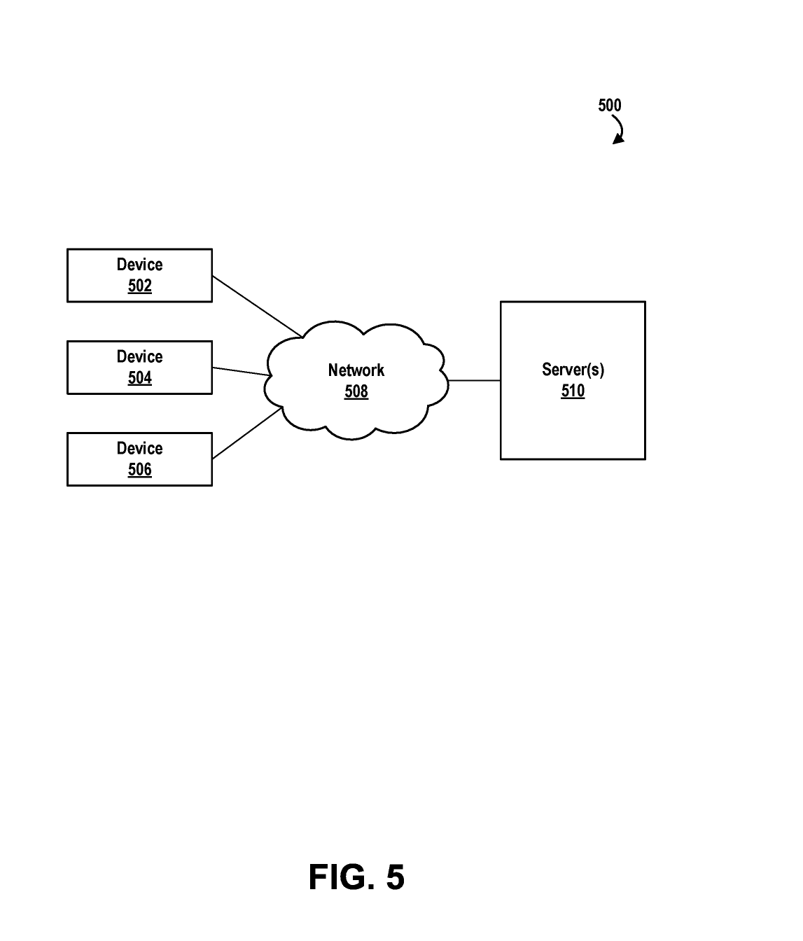

FIG. 5 is a simplified block diagram of a system 500, in which various embodiments described herein can be employed. System 500 includes client devices 502, 504, and 506, which may include desktop personal computers (PC), laptop PCs, hand-held devices (e.g., personal digital assistants), mobile phones, wearable devices (e.g., smart watches, etc.), or any other electronic device. Each of these client devices may be configured to communicate with other devices via a network 108 through the use of wireline connections and/or wireless connections.

Network 508 may include, for example, the Internet, some other form of public or private network (e.g., intranet), among other possibilities. Thus, devices 502, 504, and 506 may communicate using packet-switching technologies (e.g., Internet Protocol (IP) network, etc.), or using any other network communication technology of network 508. In some implementations, network 508 may also incorporate at least some circuit-switching technologies (e.g., gateways, etc.), and devices 502, 504, and 506 may communicate via circuit switching alternatively or in addition to packet switching. Other implementations of network 508 are possible as well.

As shown, one or more server devices 510 may also communicate via network 508. In one example, server device 510 may communicate with client devices 502, 504, and 506 according to one or more network protocols and/or application-level protocols to facilitate the use of network-based or cloud-based computing on these client devices. Server device 510 may include integrated data storage (e.g., memory, disk drives, etc.) and/or may access a separate server data storage device (not shown). Communication between server device 510 and a separate server data storage device (not shown) may be direct, via network 508, or both direct and via network 508. Whether integrated or separate, server data storage may store application data that is used to facilitate the operations of applications or processes (e.g., methods 100, 200, etc.) performed by client devices 502, 504, 506, and server device 510.

Although three client devices and one server device are shown, system 500 may include any number of each of these components. For instance, system 500 may comprise one, tens, hundreds, thousands, millions, or any other number of client devices and/or server devices.

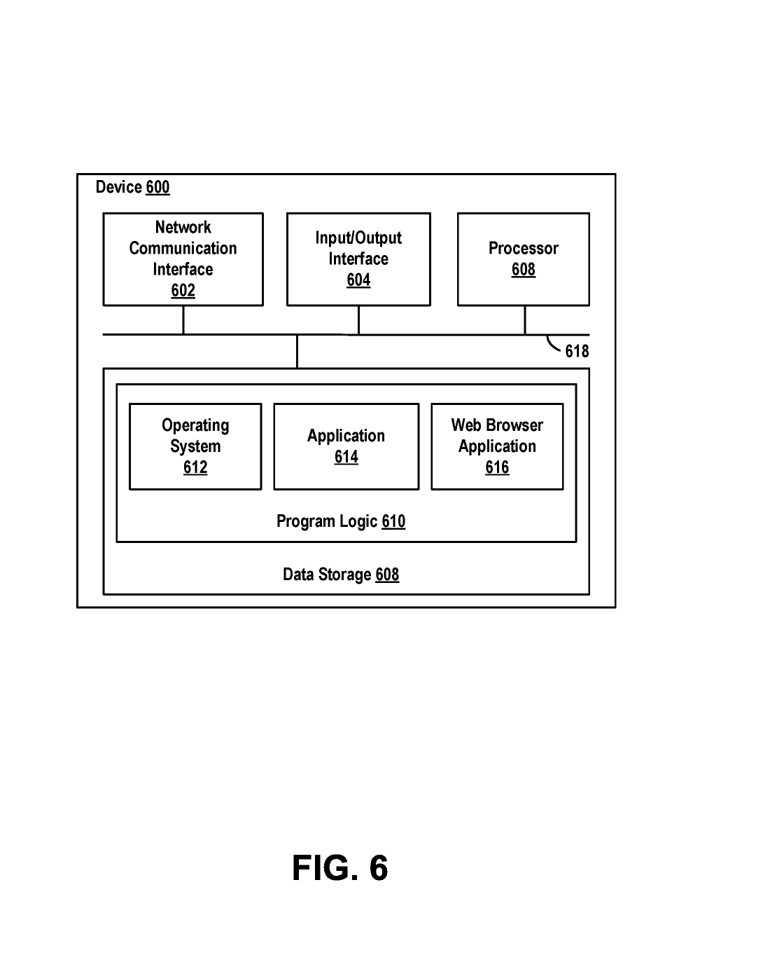

FIG. 6 is a simplified block diagram of a device 600, according to an example embodiment. Device 600 may be similar to any of the devices 502, 504, 506, and can be used to perform some or all the functions described for methods 100, 200, and/or GUIs 300, 400. In some implementations, the various components shown may be distributed across multiple devices. Thus, the various components shown are described as part of one device only for the sake of example. Further, it is noted that the functions described for the various components of device 600 may be combined or separated such that the functions are performed by fewer or more components than those shown.

Device 600 may include any computing device such as a telephone, a personal computer, or a personal digital assistant, among others. As shown, device 600 includes a network communication interface 602, an input/output (I/O) interface 604, a processor 606, and data storage 608, all of which may be communicatively linked together by a wired and/or wireless system bus, network, or other connection mechanism 618.

Communication interface 602 may be configured to allow device 600 to communicate with a network (e.g., network 608), such as an access network, a transport network, and the like. In one instance, communication interface 602 may include a chipset and antenna arranged for wireless communication with a radio access network (RAN) or any other wireless access point. In another instance, communication interface 602 may include an Ethernet interface arranged to couple with a landline or wired connection that provides connectivity with one or more networks to similarly facilitate communication with a server (e.g., server 510). Other implementations of interface 602 are possible as well, including various hardware/software configurations associated with various wired/wireless communication technologies.

I/O interface 604 may be configured to allow device 600 to interact with a user of the device 600. For example, I/O interface 604 may allow device 600 to receive user input(s) and/or to provide output(s). As such, I/O interface 604 may include input components such as a keypad or keyboard, a touch-sensitive panel, a microphone, a video camera, a touch screen, etc. Additionally or alternatively, I/O interface 604 may include output components such as a display screen and/or a sound speaker, among others. Further, in some implementations, I/O interface 604 can be alternatively implemented as an input interface and a (separate) output interface.

For example, I/O interface 604 may include an input interface (e.g., keyboard, mouse, GUI 300, etc.) that receives input parameters and user interactions, in line with the discussion at block 202 of method 200. As another example, I/O interface 604 may include an output interface (e.g., display, GUI 300, GUI 400, etc.) that displays or otherwise outputs data such as the list of phrases described at block 214 of method 200 (e.g., as a graph representation, node network representation, etc.).

Processor 606 may comprise one or more processors. In one implementation, processor 606 may comprise a single or multi-core processor, an application specific integrated circuit (ASIC), field programmable gate array (FPGA), and/or any other suitable circuitry.

Data storage 608 may include one or more volatile and/or non-volatile storage components, such as magnetic, optical, flash, organic storage, and the like. In some implementations, data storage 608 may be configured as a non-transitory computer readable medium. In some implementations, data storage 608 may be integrated in whole or in part with processor 606. As shown, data storage 608 includes program logic 610. In some implementations, data storage 608 may include additional stored data, such as social network account information (e.g., username, password, etc.) and/or any other information.

Program logic 610 may take the form of machine language instructions or other logic executable or interpretable by processor 606 to carry out various functions and methods described herein (e.g., methods 100, 200, etc.). As shown, program logic 610 may include an operating system 612 and one or more application programs, exemplified by application 614 and web browser application 616. Thus, as shown, program logic 610 may be distributed among operating system 612, application programs 612, 614, and/or one or more other software components (not shown) included in device 600 or in a remote server (e.g., server 510). In some implementations, program logic 610 may be executable by processor 606 to cause the device 600 to perform various functions of device 600, such as any of the functions described for methods 100, 200, and/or GUIs 300, 400.

Operating system 612 may include various instructions or logic for operation of the various components of device 600, and/or for facilitating communication between the various components or applications of device 600 (e.g., via connection mechanism 618, etc.).

Application 614 can be optionally included in device 600 to provide instructions for operating I/O interface 604 and other components of device 600 to perform the methods (e.g., 100, 200, etc.) of the present disclosure. In one example, application 614 may include instructions for rendering a display of a learning path (e.g., GUIs 300, 400, etc.) via a display included or operated by I/O interface 604. Thus, application 614 may include instructions for generating an input and/or output interface (e.g., graphical user interface) for receiving and/or validating inputs as well as displaying outputs. Other examples are possible as well.

Alternatively or additionally, web browser application 616 can provide at least one or more of the functions described for application 614. In some implementations, web browser application 616 may condition content communicated via I/O interface 604 and/or network communication interface 602. For instance, web browser application 616 may include instructions for conditioning data communicated with a server (e.g., server 510). Such data, for instance, may take the form of hypertext transfer protocol (HTTP) data packets and/or any other data format that web browser application 616 is configured to use for rendering a user interface (e.g., via I/O interface 604).

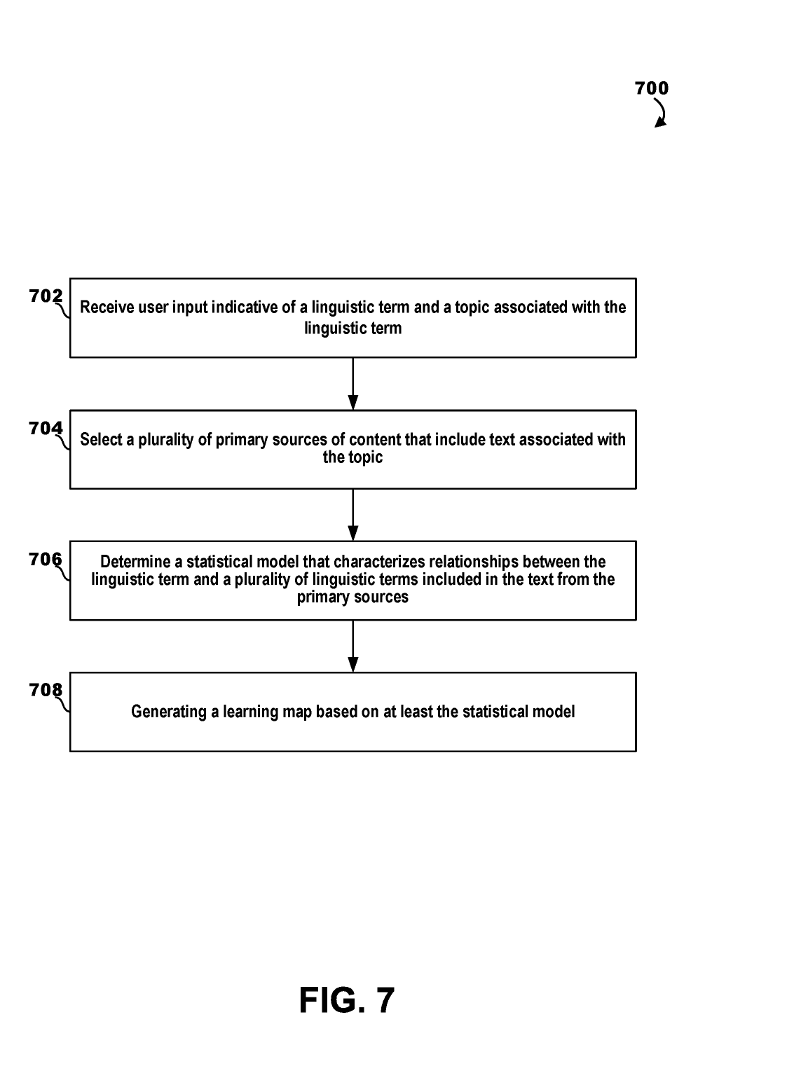

FIG. 7 is a flowchart of another method, according to an example embodiment. Method 700 depicted in FIG. 7 presents an example method that can be employed with system 500, device 600, and/or GUIs 300, 400, for instance. In some examples, method 700 may be performed by any combination of one or more suitable components described herein. FIG. 7 may include one or more operations, functions, or actions as illustrated by one or more of blocks 702-708. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

At block 702, method 700 involves receiving user input indicative of a linguistic term and a topic. For example, block 702 can be performed in line with the description of UI elements 302 and 304 of FIG. 3.

At block 704, method 700 involves selecting a plurality of primary sources of content that include text associated with the topic. Referring back to FIG. 3 for example, a user can select a topic such as “Data Communication” or any other topic. In turn, for example, a computing system of method 700 can then identify or filter documents in primary sources such as dictionaries, patent databases, etc., based on the selected topic.

At block 706, method 700 involves determining a statistical model that characterizes relationships between the linguistic term of the user input and a plurality of linguistic terms include din the text of the selected primary sources. For example, a computing system of method 700 may extract “teaching text” or “research text” from the selected primary sources, such as a concatenation of text portions (e.g., definitions, etc.) that include the linguistic term input by the user. Further, the computing system may also compute NLP statistical measurements for the linguistic term and other linguistic terms in the “teaching text.” A non-exhaustive list of example NLP statistical measurements includes frequency, context, length, number of syllables, readability index, importance score, and difficulty score, among others. Thus, the statistical model may include statistics characterizing relationships between two particular linguistic terms, as well as statistics characterizing a learning difficulty of a particular linguistic term.

At block 708, method 700 involves generating a learning map based on at least the statistical model. The learning map may include a plurality of learning paths for learning the linguistic term of the user input. For example, a given learning path may include a sequence of linguistic terms, where adjacent linguistic terms in the sequence are selected based on at least a statistical measure of a relationship (e.g., importance, relevance, etc.) between the adjacent linguistic terms. The learning path may also include linguistic terms that are selected based on a user-selected grade level or difficulty (e.g., a threshold value for the statistic, such as word length or number of syllables, suitable for teaching people in a certain age group, etc.).

In some examples, method 700 involves providing data for operating an educational curriculum development application based on the learning map. For example, data can be output in a specific format that is readable by such software application that generates an educational curriculum. Similarly, in some examples, method 700 involves providing data for operating an educational game based on the learning map.

In some examples, method 700 involves providing a display of the learning map. The display may comprise a network graph representation of the learning map (e.g., UI element 306, 308, etc. of GUI 300). In line with the discussion above, for example, the network graph representation may include a plurality of nodes and a plurality of edges between the plurality of nodes. As discussed in FIG. 3, for example, a particular node may be indicative of a particular linguistic term in the learning map and/or statistical measurements (e.g., readability index, grade level, etc.) associated with the particular linguistic term. Further, similarly to the example in FIG. 3, a given edge may be weighted according to a statistical measurement of a relationship between a first node and a second node.

In some examples, method 700 also involves receiving (e.g., via I/O interface 604) a selection of the first node and the second node; and generating a filtered learning map based on the selection, in line with the discussion of the containers in UI element 306 and the filtered learning map of UI 308. For example, the filtered learning map may exclude a learning path between the first node and a third node.

In some examples, method 700 also involves receiving, via an input interface, an indication of a threshold number of edges, and filtering the learning map accordingly, in line with the description of UI element 314.

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures. Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are contemplated herein.

What is claimed:

1. A method comprising:
receiving, by a computing device, user input indicative of a linguistic term and a topic;
selecting a plurality of primary sources that include text related to the topic;
determining, based on at least contextual use of the linguistic term in the text of the selected primary sources, a statistical model that characterizes relationships between the linguistic term of the user input and a plurality of linguistic terms included in the text of the selected primary sources; and
generating, based on at least the statistical model, a learning map that includes a plurality of learning paths for learning the linguistic term of the user input, wherein a given learning path includes a sequence of linguistic terms, and wherein adjacent linguistic terms in the sequence are selected based on at least a statistical measure of a relationship between the adjacent linguistic terms.

2. The method of claim 1, further comprising:
providing, based on the learning map, data for operating an educational curriculum development application.

3. The method of claim 1, further comprising:
providing, based on the learning map, data for operating an educational game.

4. The method of claim 1, further comprising:
providing a display of the learning map, wherein the display comprises a network graph representation of the learning map, wherein the network graph representation comprises a plurality of nodes and a plurality of edges between the plurality of nodes,
wherein a particular node is indicative of: a particular linguistic term in the learning map, statistical measurements associated with the particular linguistic term, and
wherein a given edge is weighted according to a statistical measurement of a relationship between a first node and a second node of the plurality of nodes.

5. The method of claim 4, further comprising:
selecting, from a plurality of colors, a color for the particular node based on a statistical measurement associated with the particular linguistic term of the particular node; and
displaying the particular node according to the selected color.

6. The method of claim 4, further comprising:
receiving, via an input interface of the computing device, a selection of the first node and the second node; and
generating, based on the selection, a filtered learning map that includes given learning paths between the selected nodes and that excludes at least one learning path between the first node and a third node of the plurality of nodes.

7. The method of claim 4, further comprising:
receiving, via an input interface of the computing device, an indication of a threshold number of edges; and
filtering the learning map to exclude learning paths associated with less than the threshold number of edges from a given node associated with the linguistic term of the user input.

8. The method of claim 4, further comprising:
receiving, via an input interface of the computing device, an indication of a threshold number of edges; and
filtering the learning map to exclude learning paths associated with greater than the threshold number of edges from a given node associated with the linguistic term of the user input.

9. The method of claim 4, further comprising:
displaying, via an output interface, a number of the plurality of nodes in the learning map.

10. The method of claim 1, wherein the statistical model further characterizes a grade level for each linguistic term in the learning map, wherein a particular grade level is indicative of at least a statistical measure for a difficulty of learning the particular linguistic term.

11. The method of claim 10, further comprising:
determining an average value of grade levels associated with linguistic terms indicated by the learning map; and
displaying, via a graphical user interface, an indication of the determined average value of the grade levels.

12. The method of claim 10, further comprising:
receiving input indicative of a selection of a range of grade level values; and
filtering the learning map to exclude linguistic terms that are associated with given grade level values outside the selected range.

13. A system comprising:
one or more processors;
data storage storing instructions that, when executed by the one or more processors, cause the computing system to perform operations comprising:
receiving user input indicative of a linguistic term and a topic;
selecting a plurality of primary sources that include text related to the topic;
determining, based on at least contextual use of the linguistic term in the text of the selected primary sources, a statistical model that characterizes relationships between the linguistic term of the user input and a plurality of linguistic terms included in the text of the selected primary sources; and
generating, based on at least the statistical model, a learning map that includes a plurality of learning paths for learning the linguistic term of the input, wherein a given learning path includes a sequence of linguistic terms, and wherein adjacent linguistic terms in the sequence are selected based on a statistical measure of a relationship between the adjacent linguistic terms.

14. The system of claim 13, wherein the operations further comprise:
providing, based on the learning map, data for operating an educational curriculum development application.

15. The system of claim 13, wherein the operations further comprise:
providing, based on the learning map, data for operating an educational game.

16. The system of claim 13, further comprising:
an output interface that includes a display, wherein the operations further comprise:
displaying, via the display, a network graph representation of the learning map, wherein the network graph representation comprises a plurality of nodes and a plurality of edges between the plurality of nodes,
wherein a particular node is indicative of: a particular linguistic term in the learning map, statistical measurements associated with the particular linguistic term, and
wherein a given edge is weighted according to a statistical measurement of a relationship between a first node and a second node of the plurality of nodes.

17. A non-transitory computer readable medium storing instructions that, when executed by one or more processors of a computing device, cause the computing device to perform operations comprising:
receiving user input indicative of a linguistic term and a topic;
selecting a plurality of primary sources that include text related to the topic;
determining, based on at least contextual use of the linguistic term in the text of the selected primary sources, a statistical model that characterizes relationships between the linguistic term of the user input and a plurality of linguistic terms included in the text of the selected primary sources; and
generating, based on at least the statistical model, a learning map that includes a plurality of learning paths for learning the linguistic term of the input, wherein a given learning path includes a sequence of linguistic terms, and wherein adjacent linguistic terms in the sequence are selected based on a statistical measure of a relationship between the adjacent linguistic terms.

18. The non-transitory computer readable medium of claim 17, wherein the statistical model further characterizes a grade level for each linguistic term in the learning map, wherein a particular grade level is indicative of a statistical measure of difficulty of learning the particular linguistic term.

19. The non-transitory computer readable medium of claim 18, wherein the operations further comprise:
determining an average value of grade levels associated with linguistic terms indicated by the learning map; and
displaying, via a graphical user interface, an indication of the determined average value of the grade levels.

20. The non-transitory computer readable medium of claim 18, wherein the operations further comprise:
receiving input indicative of a selection of a range of grade level values; and
filtering the learning map to exclude linguistic terms that are associated with given grade level values outside the selected range.
